(19) United States
(12) Patent Application Publication
(10) Pub. No.: US 2004/0261070 A1
(43) Pub. Date: Dec. 23, 2004

(54) Autonomic software version management system, method and program product

(75) Inventors: Brent Alan Miller, Cary, NC (US); Daniel Scott Rabinovitz, Stamford, CT (US); Patricia A. Rago, Raleigh, NC (US)

Correspondence Address: Jeanine S. Ray-Yarletts, IBM Corporation T81/503, PO Box 12195, Research Triangle Park, NC, 27709, US

(73) Assignee: International Business Machines Corporation, Armonk, NY

(21) Appl. No.: 10/465,050

(22) Filed: Jun. 19, 2003

(51) Int. Cl. G06F 9/44; G06F 9/445

(52) U.S. Cl. 717/170; 717/174

(57) ABSTRACT

Under the present invention a software version is used on a first operational level by a set (e.g., one or more) of users. As the software version is being used, its performance is automatically monitored based on predetermined monitoring criteria. Specifically, data relating to the performance of the software version is gathered. Once gathered, the data is automatically analyzed to determine if the actual performance met an expected performance. Based on the analysis, a plan is developed and executed. In particular, if the actual performance failed to meet the expected performance, the software version (or components thereof) could be revised (e.g., via patches, fixes, etc.) to correct the defects, or even rolled back to a previous operational level. Conversely, if the actual performance met or exceeded the expected performance, the software version could be promoted to a next operational level.

### BACKGROUND OF THE INVENTION

1. Field of the Invention

The present invention generally relates to an autonomic software version management system, method and program product. Specifically, the present invention provides a way to autonomically test, analyze, promote and/or deploy new versions of software.

2. Related Art

In business, it is common for organizations to implement multiple versions of software as they strive to efficiently run their businesses while keeping their systems up-to-date with the latest features and “fixes” that are available. One common method used to manage multiple software versions involves maintaining multiple operational levels of software (e.g., alpha, beta and production levels). Under such a system, new software might be installed on an alpha-level system to test its compatibility with the rest of the system, its performance, its stability, etc. It is likely that the alpha system would be a “test bed” that would be used only by people dedicated to testing its suitability for the business's needs. After some amount of testing, an organization might set up a beta-level system that is similar to the production system, but with newer versions of software components that were most likely derived from testing on the alpha-level system. A beta-level system might be deployed to a greater subset of the organization than the alpha-level system for “real-world” testing, while the remainder of the organization continues to use the current production software version. After the necessary trials at the beta-level, the software version may be deemed “ready for production,” in which case it would be promoted, replacing the existing production system. The old production system could then become the basis for a new alpha level system, to a which new software version would be added and tested.

Currently, the testing and decision-making process described above is a human-based process. For example, users operating the software version on the various operational levels must record any defects or errors, and report them to the appropriate department. Once the necessary testing data is gathered, the performance of the software version must be compared to an expected level, and then one or more individuals (e.g., administrators) must decide whether the software version is ready for promotion to the next operational level. Such a process is both expensive and inefficient. For example, lack of sufficient data to make a decision might occur in some circumstances (perhaps because not enough people or time are available to test the system as desired), which can result in delays in rolling out a new software version and/or the necessity of adding resources to test the software. Moreover, the analysis today is typically done manually with one or more persons in attendance. For example, to prove that a system has been operational for three days, someone may need to actually attend the system for that duration of time. Human intervention is also needed to examine test logs and defect reports to compare the actual performance to the expected performance. Still yet, because determining the “severity” of defects often is subjective, it could be difficult to determine whether or not any “high-severity” defects occurred.

In view of the foregoing, there exists a need for an autonomic software version management system, method and program product. Specifically, a need exists for a system that can automate the software testing, release, promotion and/or deployment process with little or no human intervention. To this extent, a need exists for a system than can automatically monitor the performance of a software version as it is being used. A further need exists for the monitored performance to be automatically compared to an expected performance. Still yet, a need exists for a plan to be automatically developed and executed based on the comparison of the monitored performance to the expected performance.

### SUMMARY OF THE INVENTION

In general, the present invention provides an autonomic software version management system, method and program product. Specifically, under the present invention a software version is used on a first (i.e., a particular) operational level by a set (e.g., one or more) of users. As the software version is being used, its performance is automatically monitored based on predetermined monitoring criteria. Specifically, data relating to the performance of the software version is gathered. Once gathered, the data is automatically analyzed to determine if the actual performance of the software version met an expected performance. Based on the analysis, a plan is developed and executed. In particular, if the actual performance failed to meet the expected performance, the software version (or components thereof) could be revised (e.g., via patches, fixes, etc.) to correct the defects, or even rolled back to a previous operational level. Conversely, if the actual performance met or exceeded the expected performance, the software version could be promoted to the next operational level.

A first aspect of the present invention provides an autonomic software version management system, comprising: a monitoring system for monitoring a performance of a software version operating on a first operational level based on predetermined monitoring criteria; an analysis system for comparing the monitored performance to an expected performance; a planning system for developing a plan for the software version based on the comparison of the monitored performance to the expected performance; and a plan execution system for executing the plan.

A second aspect of the present invention provides an autonomic software version management method, comprising: monitoring a performance of a software version operating on a first operational level based on predetermined monitoring criteria; comparing the monitored performance to an expected performance; developing a plan for the software version based on the comparison of the monitored performance to the expected performance; and executing the plan.

A third aspect of the present invention provides a program product stored on a recordable medium for managing software versions, which when executed, comprises: program code configured to monitor a performance of a software version operating on a first operational level based on predetermined monitoring criteria; program code configured to compare the monitored performance to an expected performance; program code configured to develop a plan for the software version based on the comparison of the monitored performance to the expected performance; and program code configured to execute the plan.

Therefore, the present invention provides an autonomic software version management system, method and program product.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a model for testing, releasing, promoting and/or deploying a software version, which is automated under the present invention.

FIG. 2 depicts an autonomic system software version management system for testing, releasing, promoting and/or deploying software according to the present invention.

FIG. 3 depicts a method flow diagram according to the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides an autonomic software version management system, method and program product. Specifically, under the present invention a software version is used on a first (i.e., a particular) operational level by a set (e.g., one or more) of users. As the software version is being used, its performance is automatically monitored based on predetermined monitoring criteria. Specifically, data relating to the performance of the software version is gathered. Once gathered, the data is automatically analyzed to determine if the actual performance of the software version met an expected performance. Based on the analysis, a plan is developed and executed. In particular, if the actual performance failed to meet the expected performance, the software version (or components thereof) could be revised (e.g., via patches, fixes, etc.) to correct the defects, or even rolled back to a previous operational level. Conversely, if the actual performance met or exceeded the expected performance, the software version could be promoted to the next operational level.

It should be understood in advance that the term software version is intended to refer to any type of software program that can be tested, released, promoted and/or deployed within an organization. Although the illustrative embodiment of the present invention described below refers to software versions as a software program having multiple versions, this need not be the case. For example, the present invention could be implemented to manage the testing, release, promotion and/or deployment of a software program with a single version.

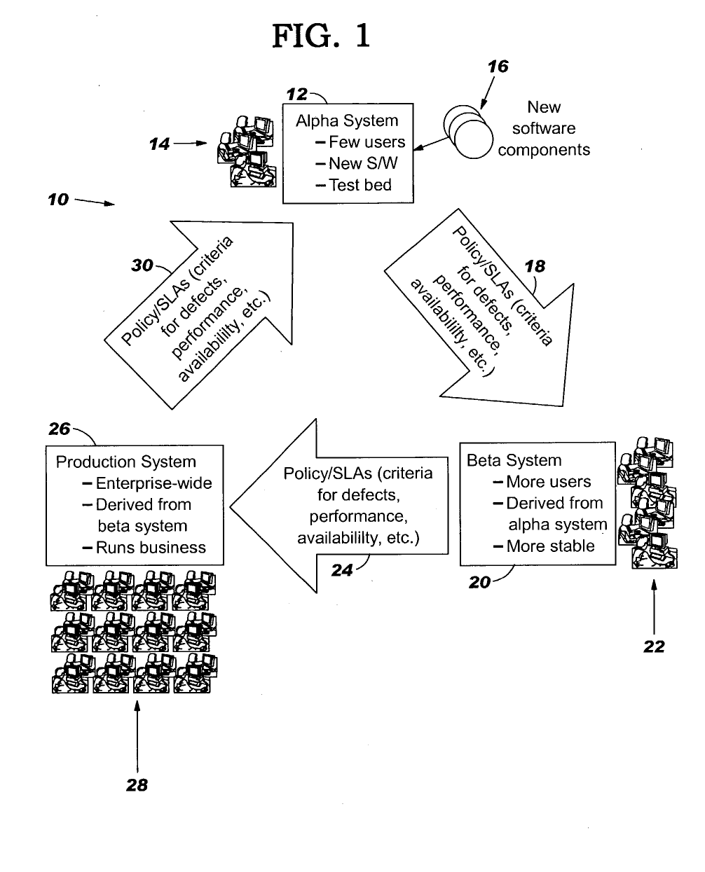

Referring now to FIG. 1, an illustrative process 10 for testing, promoting, releasing and/or deploying software is shown. As shown, process 10 includes three “operational levels” 12, 20 and 26. In general, each operational level 12, 20 and 26 represents a particular scenario under which a software version 16 is used within an organization. That is, each operation level 12, 20 and 26 could represent one or more computer systems on which software version 16 could be deployed. To this extent, each successive operational level typically represents a wider level deployment of software version 16. For example, before software version 16 is fully deployed, the organization may want to make sure it works with a small number of users 14 first (e.g., a few individuals within a single department). As such, the organization may first deploy software version 16 on “alpha” operational level 12 for a small group of users 14 as an initial test bed. If, based on any applicable rules and/or policies (i.e., criteria) 18, software version 16 satisfies the organization's requirements on “alpha” level 12, software version 16 could then be promoted to “beta” operational level 20 where it will be tested with a greater number of users 22 (e.g., an entire department). Once again, if certain criteria 24 are satisfied, software version 16 could then be deployed within the entire organization (e.g., on “production” operational level 26) for all users 28. If on any operational level 12, 20 and 26 defects in performance are observed, any necessary action could be taken. For example, patches or fixes could be installed into software version 16, software version 16 (or components thereof) could be rolled back (e.g., from “production” operational level 26 to “beta” operational level 20), etc. In addition, if software version 16 performs successfully on “production” operational level 26 according to criteria 30, it could be used as the basis for a subsequent version that begins testing on “alpha” operational level 12. Thus, process 10 could be cyclic.

As indicated above, to date the process 10 shown in FIG. 1 has required large amounts of “human” effort or intervention. That is, on each operational level, the users must note any problems that occurred, and report the problems to appropriate personnel (e.g., in the information technology (IT) department). Moreover, the decision to promote software version 16 to a subsequent operational level was typically a manual decision. That is, the IT personnel had to decide whether the performance of software version 16 was “good enough” to warrant a promotion to the next operational level. Such a methodology is both expensive and time consuming, and can often lead to inconsistent promotion decisions.

It should be understood that process 10 depicted in FIG. 1 is only intended to be illustrative. To this extent, the quantity of operational levels is not intended to be limiting. For example, an organization could have a deployment process that includes only an alpha operational level and a production operational level. Alternatively, an organization could have additional operation levels beyond those shown in FIG. 1.

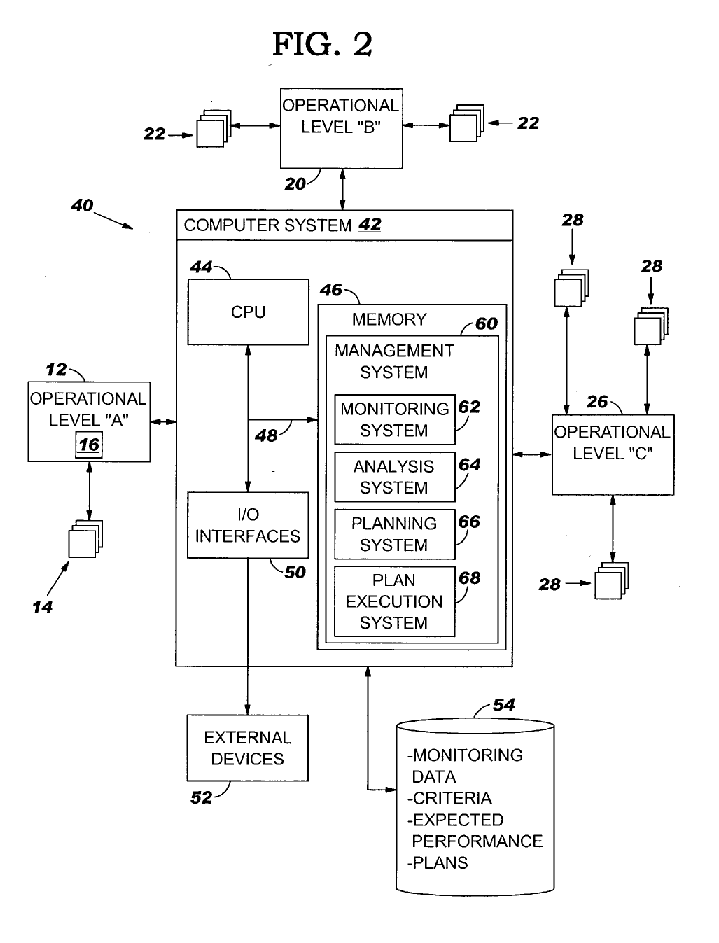

In any event, referring to FIG. 2, autonomic system 40 for software version management is shown. Autonomic system 40 automates process 10 of FIG. 1 by requiring little or no human intervention. As depicted, system 40 includes computer system 42 that communicates with operational levels 12, 20 and 26 (whose functions are similar to those shown in FIG. 1). For example, as described in conjunction with FIG. 1, each operational level 12, 20 and 26 could include one or more computer systems on which a software version 16 operates. In general, computer system 42 is intended to represent any computerized system capable of carrying out the functions of the present invention described herein. For example, computer system 42 could be a personal computer, a workstation, a server, a laptop, a hand-held device, etc. In any event, via management system 60, computer system 42 is used to automatically monitor and analyze the performance of software version 16 on each operational level 12, 20 and 26, and to develop and execute a plan for addressing the performance.

As shown, computer system 42 generally comprises central processing unit (CPU) 44, memory 46, bus 48, input/output (I/O) interfaces 50, external devices/resources 52 and storage unit 54. CPU 44 may comprise a single processing unit, or be distributed across one or more processing units in one or more locations, e.g., on a client and server. Memory 46 may comprise any known type of data storage and/or transmission media, including magnetic media, optical media, random access memory (RAM), read-only memory (ROM), a data cache, a data object, etc. Moreover, similar to CPU 44, memory 46 may reside at a single physical location, comprising one or more types of data storage, or be distributed across a plurality of physical systems in various forms.

I/O interfaces 50 may comprise any system for exchanging information to/from an external source. External devices/resources 52 may comprise any known type of external device, including speakers, a CRT, LCD screen, hand-held device, keyboard, mouse, voice recognition system, speech output system, printer, monitor/display, facsimile, pager, etc. Bus 48 provides a communication link between each of the components in computer system 42 and likewise may comprise any known type of transmission link, including electrical, optical, wireless, etc.

Storage unit 54 can be any system (e.g., a database) capable of providing storage for information such as monitoring data, monitoring criteria, performance criteria, planning criteria, etc., under the present invention. As such, storage unit 54 could include one or more storage devices, such as a magnetic disk drive or an optical disk drive. In another embodiment, storage unit 54 includes data distributed across, for example, a local area network (LAN), wide area network (WAN) or a storage area network (SAN) (not shown). It should also be understood that although not shown, additional components, such as cache memory, communication systems, system software, etc., may be incorporated into computer system 42.

Communication between operational levels 12, 20 and 26 and computer system 42 could occur via any known manner. For example, such communication could occur via a direct hardwired connection (e.g., serial port), or via an addressable connection in a client-server (or server-server) environment that may utilize any combination of wireline and/or wireless transmission methods. In the case of an addressable connection, the server and client may be connected via the Internet, a wide area network (WAN), a local area network (LAN), a virtual private network (VPN) or other private network. The server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server.

It should be understood that the one or more computer systems that comprise each operational level 12, 20 and 26 will typically each include computerized components similar to computer system 42. Such components have not be depicted for brevity purposes.

Shown in memory 46 of computer system 42 is management system 60, which includes monitoring system 62, analysis system 64, planning system 66 and plan execution system 68. As software version 16 is used on the operational levels, such as operational level “A” 12 as shown, monitoring system 62 will monitor its performance based on predetermined monitoring criteria (e.g., rules, policies, service level agreements, etc., as stored in storage unit 54). Specifically, as users 14 (e.g., a few individuals within a particular department) use software version 16, monitoring system 62 will collect data relating to one or more performance characteristics. Such characteristics could include, for example: (1) reliability (e.g., how many defects are found); (2) availability (e.g., how long a system stays operational); (3) serviceability (e.g., how hard it is to determine that a problem exists; (4) what needs to be fixed; projected and actual fix times, etc.); (5) usability (e.g., how difficult it is it to configure and operate the system); (6) performance (e.g., how fast the system runs and how much of a load it can handle); (7) installability (e.g., how difficult it is to install new software); and (8) documentation quality (e.g., how relevant and effective the documentation, on-line help information, etc. is). To monitor the performance using these characteristics, one or more “sensors” (e.g., programmatic APIs) will be used by monitoring system 62. As monitoring is occurring, monitoring system 62 will gather the pertinent data and store the same in storage unit 54. For example, if software version 16 operated for ten hours on operational level “A” 12 during which five “defects” or errors were observed, monitoring system 62 could store a reliability factor of “0.5 defects per hour.”

Once all necessary data has been gathered, analysis system 64 will parse and analyze the data. Specifically, analysis system 64 will compare the monitored/actual performance of software version 16 to an expected performance. To this extent, analysis system 64 could compare the data in storage unit 54 to some predetermined performance criteria (e.g., as also stored in storage unit 54). For example, the monitored reliability of software version 16 (e.g., 0.5 defects per hour) could be compared to an expected or acceptable reliability (e.g., <0.2 defects per hour). Once the comparison of monitored performance to expected performance has been made, planning system 66 will utilize planning criteria within storage unit 54 to develop a plan for the software version based on the comparison. The plan can incorporate any necessary actions to properly address the analysis. For example, if defects or errors were observed, the plan could involve the installation of patches or fixes into the software version 16. In addition, if performance failed to meet expectations, the plan could call for a “rollback” of the software version (e.g., to a previous version or to a previous operational level). For example, if software version 16 failed to meet expectations on operational level “B” 20, a plan could be developed that resulted in software version 16 being rolled back to operational level “A” 12 for additional testing. Conversely, if software version 16 met or exceeded expectations, it could be “promoted” to a subsequent operational level. In any event, once the plan is developed, plan execution system 68 will execute the plan. Accordingly, if the plan called for fixes or patches to be installed, plan execution system 68 would execute the installation. Similarly, plan execution system 68 would implement any promotion or rollback of software version 16 as indicated by the developed plan.

Assume in this example that software version 16 met expectations on operational level “A” 12. In this event software version 16 would be “promoted” to operational level “B” 20, where it would be tested by a larger set of users 22 (e.g., an entire department). Management system 60 would then perform the same tasks. Specifically, based on predetermined monitoring criteria, monitoring system 62 would gather data relating the performance of software version 16 on operational level “B” 20. Then, based on performance criteria (which may or may not be the same as used for operational level “A” 12), analysis system 64 would compare the monitored performance to an expected performance. Based on the comparison, planning system 66 would develop a plan for software version 16 that plan execution system 68 would execute. For example, if the monitored performance fell below expectations, patches or fixes could be installed, or software version 16 could be rolled back operational level “A” 12. However, if the monitored performance met or exceeded expectations software version 16 could be promoted from operational level “B” 20 to operational level “C” 26 (e.g., full deployment).

After promotion to operational level “C” 26, the process would then be repeated again as software version was used by an even larger set of users 28 (e.g., the whole company). The monitoring of the performance of software version 16 on operational level “C” 26 could provide several advantages. First, it will be monitored to ensure that software version 16 is meeting the performance criteria set of operational level “C” 26 (which may or may not be the same used for operational level “A” 12 and/or “B” 20). If the monitored performance is not meeting expectations, patches or fixes could be installed, or software version 16 could be rolled back to operational level “B” 20 or “A” 12. However, if software version 16 meets expectations, it could be the basis for a newer software version, which would begin testing on operational level “A” 12. Accordingly, the present invention manages and automates the testing release, promotion and deployment cycle for software.

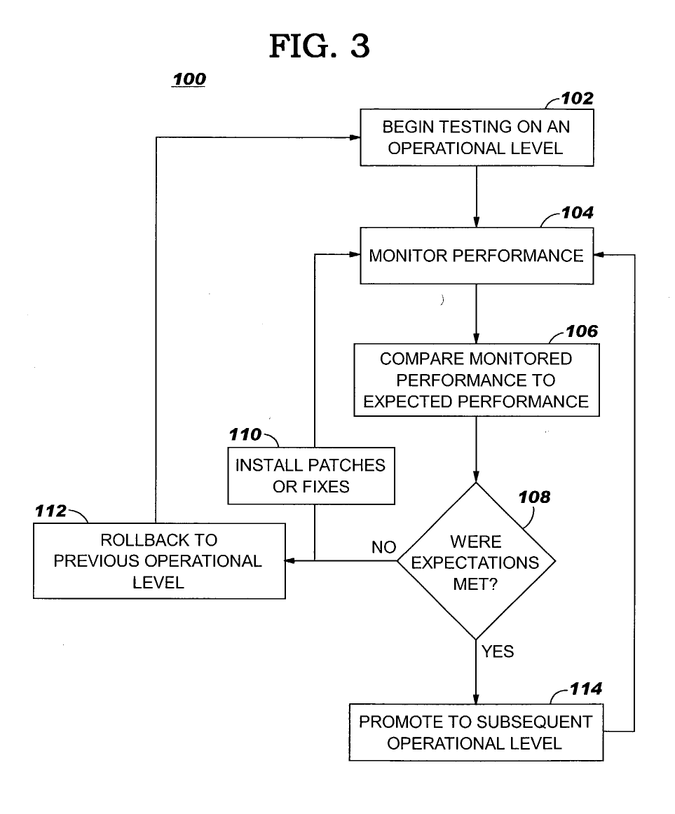

Referring now to FIG. 3, a method flow diagram 100 according to the present invention is shown. As depicted, the testing commences on an operational level 102. As the software version is being tested, its performance is monitored in step 104. The monitored performance is then compared to an expected performance in step 106. In step 108, it is determined whether expectations were met. Specifically, it is determined whether the monitored performance met the expected performance. If not, patches or fixes could be installed in step 110, after which the performance of the software version would be monitored again. Moreover, if the monitored performance failed to meet expectations, the software version could be rolled back to a previous operational level 112 where it would be re-tested. Conversely, if expectations were met, the software version could be promoted in step 114 to a subsequent operational level where its performance would be monitored and analyzed again.

It should be understood that the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

We claim:

1. An autonomic software version management system, comprising:
a monitoring system for monitoring a performance of a software version operating on a first operational level based on predetermined monitoring criteria;
an analysis system for comparing the monitored performance to an expected performance;
a planning system for developing a plan for the software version based on the comparison of the monitored performance to the expected performance; and
a plan execution system for executing the plan.

2. The system of claim 1, wherein the performance is monitored based on use of the software version by a set of users operating on the first operational level.

3. The system of claim 1, wherein the monitoring system gathers data corresponding to the performance of the software version operating on the first testing level, and wherein the analysis system analyzes the data to determine whether the performance of the software version meets the expected performance.

4. The system of claim 3, wherein the data is stored in a storage unit by the monitoring system, and wherein the storage unit is accessed by the analysis system for analysis.

5. The system of claim 1, wherein the planning system develops a plan to promote the software version to a second operational level if the monitored performance meets the expected performance.

6. The system of claim 1, wherein the analysis system identifies a set of defects in the software version if the monitored performance fails to meet the expected performance, and wherein the planning system develops a plan to correct the set of defects.

7. The system of claim 1, wherein the planning system develops a plan to rollback the software version to a previous operational level if the monitored performance fails to meet the expected performance.

8. The system of claim 1, wherein the predetermined monitoring criteria comprises at least one performance characteristic selected from the group consisting of reliability, availability, serviceability, usability, speed, capacity, installability and documentation quality.

9. An autonomic software version management method, comprising:
monitoring a performance of a software version operating on a first operational level based on predetermined monitoring criteria;
comparing the monitored performance to an expected performance;
developing a plan for the software version based on the comparison of the monitored performance to the expected performance; and
executing the plan.

10. The method of claim 9, wherein the performance is monitored based on use of the software version by a set of users operating on the first operational level.

11. The method of claim 9, wherein the monitoring step comprises gathering data corresponding to the performance of the software version operating on the first testing level, and wherein the comparing step comprises analyzing the data to determine whether the performance of the software version meets the expected performance.

12. The method of claim 11, further comprising:
storing the data in a storage unit, and
accessing the storage unit for the analysis.

13. The method of claim 9, wherein the planning system develops a plan to promote the software version to a second operational level if the monitored performance meets the expected performance.

14. The method of claim 9, wherein the analysis system identifies a set of defects in the software version if the monitored performance fails to meet the expected performance, and wherein the planning system develops a plan to correct the set of defects.

15. The method of claim 9, wherein the planning system develops a plan to rollback the software version to a previous operational level if the monitored performance fails to meet the expected performance.

16. The method of claim 9, wherein the predetermined monitoring criteria comprises at least one performance characteristic selected from the group consisting of reliability, availability, serviceability, usability, speed, capacity, installability and documentation quality.

17. A program product stored on a recordable medium for managing software versions, which when executed, comprises:
program code configured to monitor a performance of a software version operating on a first operational level based on predetermined monitoring criteria;
program code configured to compare the monitored performance to an expected performance;
program code configured to develop a plan for the software version based on the comparison of the monitored performance to the expected performance; and
program code configured to execute the plan.

18. The program product of claim 17, wherein the performance is monitored based on use of the software version by a set of users operating on the first operational level.

19. The program product of claim 17, wherein the program code configured to monitor gathers data corresponding to the performance of the software version operating on the first testing level, and wherein the program code configured to compare analyzes the data to determine whether the performance of the software version meets the expected performance.

20. The program product of claim 19, wherein the data is stored in a storage unit and then accessed for analysis.

21. The program product of claim 17, wherein the program code configured to develop a plan develops a plan to promote the software version to a second operational level if the monitored performance meets the expected performance.

22. The program product of claim 17, wherein the program code configured to compare identifies a set of defects in the software version if the monitored performance fails to meet the expected performance, and wherein the program code configured to develop a plan develops a plan to correct the set of defects.

23. The program product of claim 17, wherein the program code configured to develop a plan develops a plan to rollback the software version to a previous operational level if the monitored performance fails to meet the expected performance.

24. The program product of claim 17, wherein the predetermined monitoring criteria comprises at least one performance characteristic selected from the group consisting of reliability, availability, serviceability, usability, speed, capacity, installability and documentation quality.
